(19) United States
(12) Patent Application Publication
(10) Pub. No.: US 2024/0291246 A1
(43) Pub. Date: Aug. 29, 2024

(54) ARTICULATING FRAME FOR A MOBILE ELECTRICAL APPARATUS

(71) Applicant: Eaton Intelligent Power Limited, Dublin (IE)

(72) Inventors: Sagar Shete, Pune (IN); Prasad Dharmadhikari, Pune (IN)

(21) Appl. No.: 18/404,073

(22) Filed: Jan. 4, 2024

(30) Foreign Application Priority Data
Feb. 27, 2023 (IN) 202311013083

(51) Int. Cl. H02B 1/52; H02B 7/00

(52) U.S. Cl. CPC H02B 1/52; H02B 7/00

(57) ABSTRACT

A frame for an electrical apparatus includes: a plurality of support structures configured to hold one phase component of the electrical apparatus; and a plurality of base portions. Each base portion is connected to first joint assembly on a first one of the plurality of support structures and to a second joint assembly on a second one of the plurality of support structures. Each base portion is configured to rotate about a joint in the first joint assembly and a joint in the second joint assembly between a working position and a transport position.

### CROSS-REFERENCE TO RELATED APPLICATION

This application claims priority to Indian Patent Application 202311013083, filed Feb. 27, 2023 and titled ARTICULATING FRAME FOR A MOBILE ELECTRICAL APPARATUS, which is incorporated herein by reference in its entirety.

### TECHNICAL FIELD

This disclosure relates to an articulating frame for a mobile electrical apparatus.

### BACKGROUND

A mobile electrical system can be temporarily installed in a facility and connected to a power grid. The mobile electrical system also can be transported to another location and temporarily installed and connected to the power grid in the other location.

### SUMMARY

In one aspect, a mobile electrical system includes: a frame configured to be transitioned between a working arrangement and a transport arrangement. The frame includes: a first support structure; a second support structure; and a third support structure; a first base portion attached to the first support structure at a first joint assembly and to the second support structure at a second joint assembly, the first base portion configured to rotate relative to first support structure at the first joint assembly and to rotate relative to the second support structure at the second joint assembly; and a second base portion attached to the second support structure at a third joint assembly and to the third support structure at a fourth joint assembly, the second base portion configured to rotate relative to the second support structure at the third joint assembly and the rotate relative to the third support structure at the fourth joint assembly. The mobile electrical system also includes: a first phase component of an electrical apparatus mounted to the first support structure; a second phase component of the electrical apparatus mounted to the second support structure; and a third phase component of the electrical apparatus mounted to the third support structure. When the frame is in the working arrangement, the first base portion extends substantially perpendicular to the second support structure such that the first phase component of the electrical apparatus and the second phase component of the electrical apparatus are separated at least by a dielectric breakdown distance, and the second base portion extends substantially perpendicular to the second support structure such that the second phase component of the electrical apparatus and the third phase component of the electrical apparatus are separated at least by the dielectric breakdown distance, and, when the frame is in the transport arrangement, the first base portion and the second base portion are substantially parallel to the first support structure, the second support structure, and the third support structure; and a width of the frame is less than the width of the frame in the working arrangement.

Implementations may include one or more of the following features.

The first joint assembly may include a first locking mechanism configured to hold the first base portion perpendicular to the first support structure when the frame is in the working arrangement and to hold the first base portion parallel to the first support structure when the frame is in the transport arrangement; the second joint assembly may include a second locking mechanism configured to hold the first base portion perpendicular to the second support structure when the frame is in the working arrangement and to hold the first base portion parallel to the second support structure when the frame is in the transport arrangement; the third joint assembly may include a third locking mechanism configured to hold the second base portion perpendicular to the second support structure when the frame is in the working arrangement and to hold the second base portion parallel to the second support structure when the frame is in the transport arrangement; and the fourth joint assembly may include a fourth locking mechanism configured to hold the second base portion perpendicular to the third support structure when the frame is in the working arrangement and to hold the second base portion parallel to the third support structure when the frame is in the transport arrangement. The first base portion may include: a first flange that defines a first flange opening, and a second flange that defines a second flange opening; and the second base portion may include: a third flange that defines a third flange opening, and a fourth flange that defines a fourth flange opening. The first locking mechanism may include: a first plate that defines a working position opening and a transport position opening, and a first pin; the second locking mechanism may include: a second plate that defines a working position opening and a transport position opening, and a second pin; the third locking mechanism may include: a third plate that defines a working position opening and a transport position opening, and a third pin; and the fourth locking mechanism may include: a fourth plate that defines a working position opening and a transport position opening, and a fourth pin.

The electrical apparatus may be a capacitor bank rated for at least 150 kilovolts (kV).

Each of the first phase component, the second phase component, and the third phase component may include a capacitor, an arrester, and a line connection.

Each of the first joint assembly, the second joint assembly, and the third joint assembly may include a damper.

In another aspect, a frame for an electrical apparatus includes: a plurality of support structures configured to hold one phase component of the electrical apparatus; and a plurality of base portions, each connected to first joint assembly on a first one of the plurality of support structures and to a second joint assembly on a second one of the plurality of support structures. Each base portion is configured to rotate about a joint in the first joint assembly and a joint in the second joint assembly between a working position and a transport position.

Implementations may include one or more of the following features.

Each joint assembly may be lockable in the working position and the transport position. Each joint assembly may include a locking pin, and, in these implementations, when the locking pin is inserted in the joint assembly, the joint assembly is locked; and when the locking pin is not inserted in the joint assembly, the joint assembly is unlocked.

The base portion may be configured to be rotated about the joints in response to manual manipulation.

Each of the first and second joint assemblies may include a damper configured to interact with one of the base portions when the base portion is rotated into the working position.

Implementations of any of the techniques described herein may include a system, an apparatus, a frame for a mobile electrical apparatus, a mobile electrical apparatus, or a method. The details of one or more implementations are set forth in the accompanying drawings and the description below. Other features will be apparent from the description and drawings, and from the claims.

### DRAWING DESCRIPTION

FIGS. 1A and 1B show an example of a mobile system.

FIGS. 2A and 2B are top views of the mobile system of FIGS. 1A and 1B.

FIGS. 3A and 3B are perspective views of another example of a mobile system.

FIGS. 4A-4D are top views of an example of an articulating frame.

FIG. 5A is a perspective side view of an example of a joint for an articulating frame.

FIG. 5B is a perspective side view of an example of a first joint portion of the joint of FIG. 5A.

FIG. 5C is a perspective side view of an example of a second joint portion of the joint of FIG. 5A.

FIGS. 6A and 6B are perspective views of an example of a joint assembly that includes the joint of FIG. 5A.

FIGS. 7A and 7B are perspective views of an example of another joint assembly that includes the joint of FIG. 5A.

FIG. 8 is a perspective side view of an example of a locking pin.

FIG. 9 is a perspective top view of an example of a damper.

### DETAILED DESCRIPTION

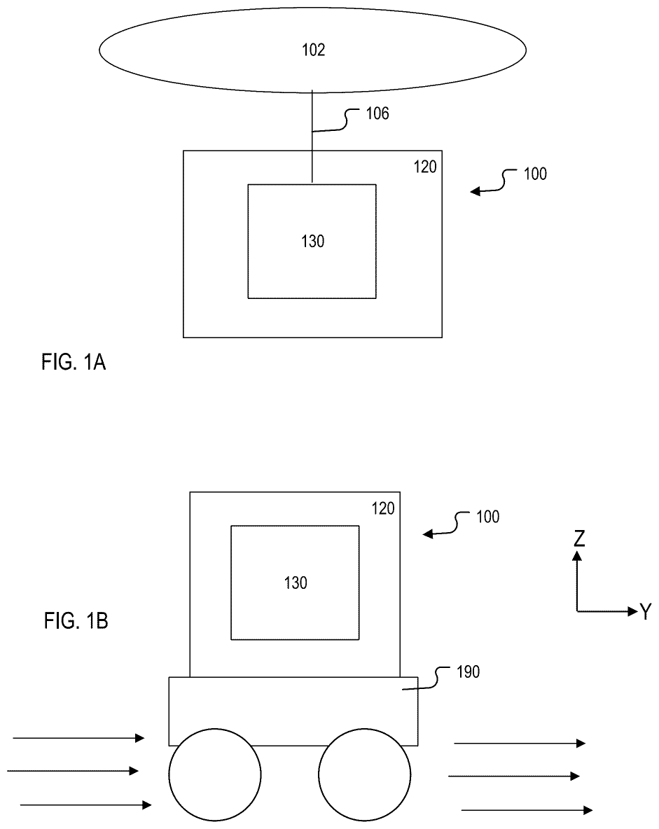

FIGS. 1A and 1B show an example of a mobile system 100. The mobile system 100 includes a frame 120 that holds a multi-phase electrical apparatus 130. The multi-phase electrical apparatus 130 may be any multi-phase electrical apparatus that includes a component for each phase. Specific examples of the apparatus 130 include, without limitation, a capacitor bank, a network protector, a circuit breaker, a recloser, a disconnect, an arrester set, and a substation.

The frame 120 has a working arrangement (FIG. 1A) and a transport arrangement (FIG. 1B). In the working arrangement, the frame 120 is in a spatially expanded configuration and holds the electrical apparatus 130 while the electrical apparatus 130 is connected to an alternating current (AC) power system or grid 102 by an electrical connection 106. The electrical grid 102 is a multi-phase electrical network that provides electricity to commercial, industrial, government, and/or residential customers. The electrical grid 102 may have an operating voltage of, for example, at least 1 kilovolt (kV), up to 34.5 kV, up to 38 kV, or 69 kV or higher, and may operate at a fundamental frequency of, for example, 50 or 60 Hertz (Hz). The grid 102 may include, for example, one or more transmission lines, distribution lines, electrical cables, transformers, generators, renewable resources, distributed energy resources, and/or any other mechanism for transmitting, generating, or consuming electricity.

In the transport arrangement, the electrical apparatus 130 is not connected to the grid 102 and the frame 120 is in a spatially compressed or collapsed configuration. The collapsed frame 120 holds the electrical apparatus 130 while the system 100 is transported from one location to another by a transportation platform 190. The transportation platform 190 may be, for example, a trailer that is towed as part of a tractor-trailer vehicle; a flatbed that is towed by a truck or other vehicle; or a container that is transported by a truck, train, or ship.

As discussed in greater detail below, the frame 120 is an articulating frame that includes rotatable base portions.

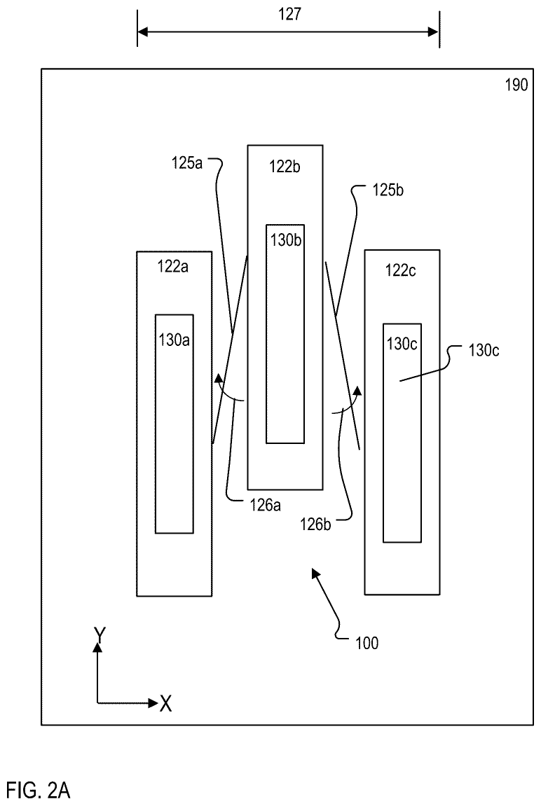

FIGS. 2A and 2B are top views of the mobile system 100. FIG. 2A shows the mobile system with the frame 120 in the transport arrangement (or racked-in configuration) on the transportation platform 190. FIG. 2B shows the mobile system 100 in the working arrangement (or racked-out configuration) while temporarily installed at a facility 192. The facility 192 may be, for example, a power plant, an industrial plant, a hospital, a disaster area, an outdoor region, or a utility station. The facility 192 may be indoors or outdoors. When the frame 120 is in the working arrangement, the electrical apparatus 130 may be connected to the power system 102 (FIG. 1A).

The frame 120 includes support structures 122a, 122b, 122c and base portions 125a, 125b. The base portion 125a is connected to the support structure 122a and to the support structure 122b. The base portion 125b is connected to the support structure 122b and the support structure 122c. Each support structure 122a, 122b, 122c holds a respective phase component 130a, 130b, 130c of the electrical apparatus 130. Each phase component 130a, 130b, 130c is configured for electrical connection to one phase of the power grid 102. The phase components 130a, 130b, 130c are identical and include specific devices and apparatuses that vary depending on the nature of the electrical apparatus 130. For example, in implementations in which the electrical apparatus 130 is a capacitor bank, each phase component 130a, 130b, 130c includes one or more capacitors and also may include arresters and line connections. In implementations in which the electrical apparatus is a recloser, each phase component 130a, 130b, 130c includes a resettable current interrupter, such as, for example, a vacuum interrupter.

In the transport arrangement (FIG. 2A), the base portion 125a and the base portion 125b are positioned such that the support structure 122a and the support structure 122c are relatively close to the support structure 122b. In the transport arrangement, the frame 120 is collapsed and has a width of 127 in the X direction. The width 127 is smaller than the width of common transportation containers and platforms such that the system 100 can be efficiently transported. For example, the width 127 may be 121 inches (about 307 centimeters).

The frame 120 is an articulating frame. The base portion 125a rotates relative to the support structure 122a and the support structure 122b, and the base portion 125b rotates relative to the support structure 122b and the support structure 122c. To transition the frame 120 from the transport arrangement (FIG. 2A) to the working arrangement (FIG. 2B), an operator moves the base portion 125a along an arc 126a and the base portion 125b along an arc 126b. Moving the base portion 125a and the base portion 125b in this manner causes the frame 120 to expand in the X direction.

In the working arrangement, the frame 120 has a width 128 in the X direction. The width 128 is greater than the width 127. For example, the width 128 may be 220 inches (about 558 cm) or greater. Furthermore, when the frame 120 is in the working arrangement, the support structure 122b is separated from the support structure 122a by a component distance 129a in the X direction, and the support structure 122b is separated from the support structure 122c by a component distance 129b in the X direction. The component distance 129a is the dielectric distance between the components 130a and 130b, and the component distance 129b is the dielectric distance between the components 130b and 130c. The voltage necessary for an electric arc to form between two electrodes depends on the distance between the electrodes, with the voltage at which arcing occurs increasing with distance. The dielectric distance is the minimum distance between two electrodes for which no arcing will occur at a particular voltage. The component distances 129a and 129b are such that there is no arcing between the components 130a, 130b, 130c under ordinary operating conditions of the electrical apparatus 130. The specific values of the distances 129a and 129b depend on the operating voltage of the components 130a, 130b, 130c. In implementations in which each component 130a, 130b, 130c is identical, the component distances 129a and 129b are equal.

Traditional reconfigurable frames for mobile electrical apparatuses include hollow beam members that are connected to support regions, each of which holds a component or pole of a multi-phase electrical apparatus. To collapse these traditional frames from a racked-out or working arrangement to a racked-in arrangement, the support regions are moved closer together by sliding some of the beam members into corresponding openings of other beam members. To expand these traditional frames from the racked-in to the racked-out arrangement, the beam members are pulled out of the openings. In other words, the expansion and collapsing of the frame relies on sliding the beam members into or out of other beam members.

These traditional frames may present challenges. For example, sliding the beam members relative to each other takes a relatively large amount of force, and these traditional frames rely on motors to slide the beam members. Furthermore, because the beam members slide parallel and concentrically with each other, the width of the collapsed frame along the direction of the beam members is dictated by the dielectric distance between the components or poles of the multi-phase electrical apparatus in the racked-out arrangement. Thus, these traditional frames are not optimal or practical for use with electrical apparatuses with higher voltage ratings (for example, a voltage rating of 160 kilovolts or greater). Finally, because of the reliance on sliding beam members into and out of the opening of other beam members, some of the beam members have larger diameters than other beam members, and this increases the amount of material needed for these traditional frame.

On the other hand, the frame 120 is an articulating frame that does not rely on sliding beam members. The base portions 125a and 125b rotate relative to the support structure 122b instead of sliding relative to each other. The rotating or articulating aspect of the frame 120 allows the frame to collapse such that the width 127 of the transport arrangement is small enough to fit into common transport containers and/or onto common transport platforms while also allowing the frame 120 to provide a relatively larger separation distance 129a, 129b in the working arrangement. As compared to the traditional sliding frame, the frame 120 may be used in higher voltage and/or higher current applications. For example, the frame 120 may be used to support a capacitor bank rated for 161 kilovolts (kV). Furthermore, rotating the base portions 125a and 125b uses less force than the sliding mechanism of the traditional frame, and the frame 120 may be transitioned between the working arrangement and the transport arrangement manually and without the use of motors or other machinery. Finally, the frame 120 may be constructed with less material than the traditional frame because neither the base portion 125a nor the base portion 125b has an increased diameter to accept the other.

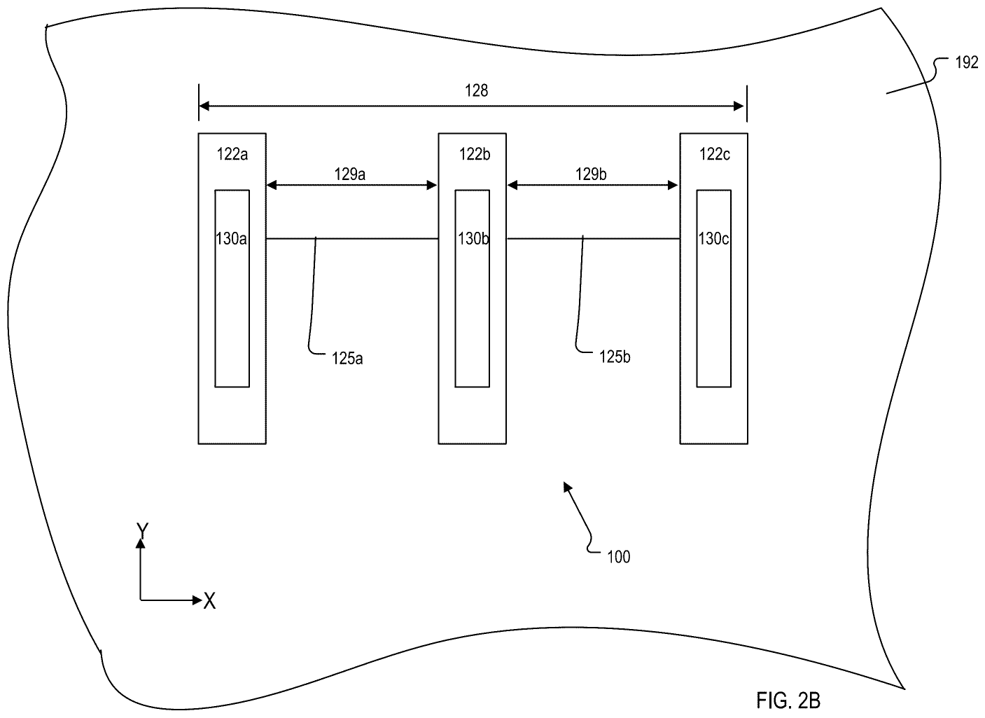

FIGS. 3A and 3B are perspective views of another example mobile system 300. FIG. 3A shows the mobile system 300 in a working arrangement or racked-out. FIG. 3B shows the mobile system 300 in a transport arrangement or racked-in. In the working arrangement, the frame 320 has an extent 328 in the X direction and an extent 331 in the Y direction. In the transport arrangement, the frame 320 has an extent 327 in the X direction and an extent 333 in the Y direction. The extent 328 is greater than the extent 327. The extent 331 is smaller than the extent 333, but the area of the frame 320 in the X-Y plane is smaller when the frame 320 is in the transport arrangement than in the working arrangement.

The mobile system 300 includes a frame 320 and a capacitor bank that includes poles 330a, 330b, 330c. Each pole 330a, 330b, 330c includes insulators that extend in the Z direction and an arrestor and line connection that extend in the Y direction. The line connection connects the pole to a phase of a power grid (such as the power grid 201).

The frame 320 includes a support structure 322a that holds the pole 330a, a support 322b that holds the pole 330b, and a support structure 322c that holds the pole 330c. The frame 320 also includes base portions 325_1, 325_2, 325_3, 325_4 (collectively called the base portions 325). A connector plate 335_1 extends in the −X and X directions from one end of the support structure 322b, and a connector plate 335_2 extends in the −X and X directions from the other end of the support structure 322b.

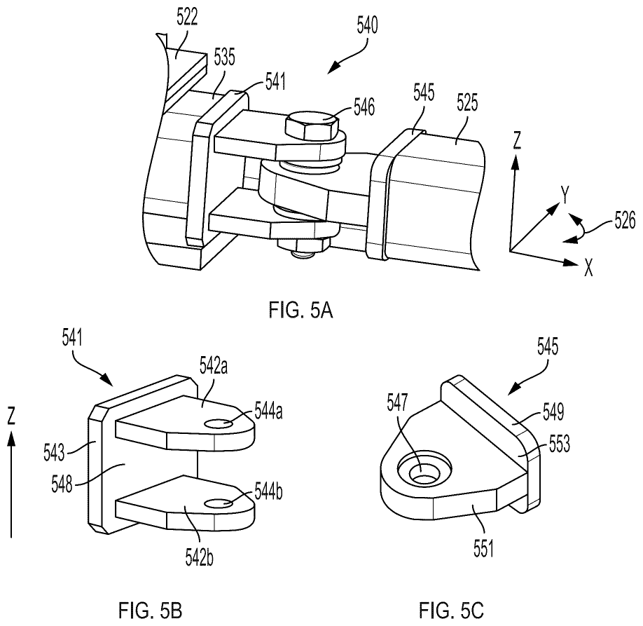

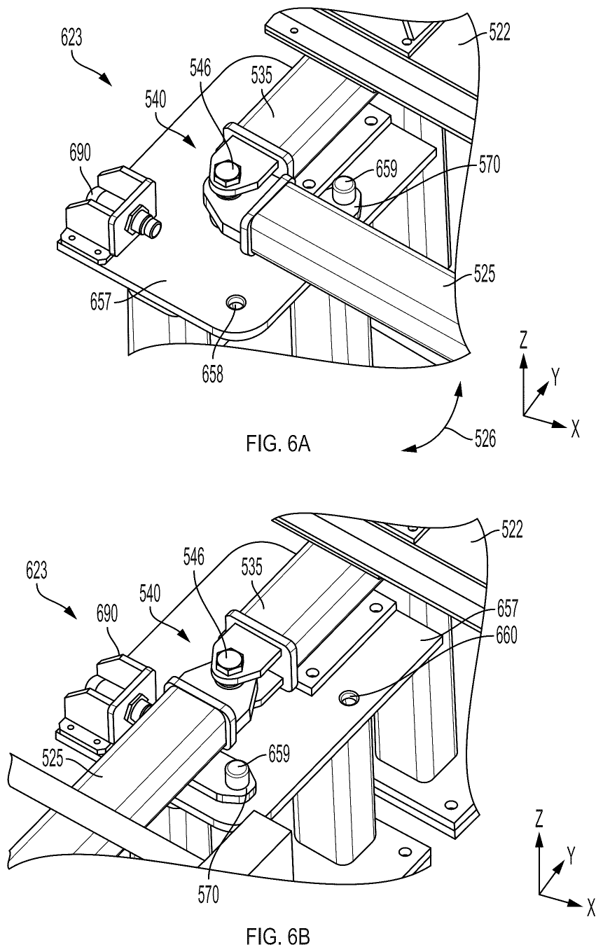

The frame 320 also includes joint assemblies 323_1, 323_2, 323_3, 323_4, 323_5, 323_6, 323_7, 323_8 (collectively called the joint assemblies 323). Each base portion 325 is connected to two joint assemblies 323 such that each base portion 325 can rotate relative to the other two base portions 325. The joint assemblies 323 are lockable. Thus, although the base portions 325 can rotate, the base portions 325 may be held in a fixed spatial relationship with the support structures 322a, 322b, 322c by locking the joint assemblies 323. FIGS. 6A-7B show examples of a joint assembly.

The joint assemblies 323_1 and 323_5 are on opposite ends of the support structure 322a. The joint assemblies 323_4 and 323_8 are on opposite ends of the support structure 322c. The joint assembly 323_2 extends in the −X direction from the connector plate 335_1, and the joint assembly 323_3 extends in the X direction from the connector plate 335_1. The joint assembly 323_6 extends in the −X direction from the connector plate 335_2, and the joint assembly 323_7 extends in the X direction from the connector plate 335_2.

The joint assembly 323_1 is connected to one end of the base portion 325_1, and the joint assembly 323_2 is connected to the other end of the base portion 325_1. The joint assembly 323_3 is connected to one end of the base portion 325_2, and the joint assembly 323_4 is connected to the other end of the base portion 325_2. The joint assembly 323_5 is connected to one end of the base portion 325_3, and the joint assembly 323_6 is connected to the other end of the base portion 325_3. The joint assembly 323_7 is connected to one end of the base portion 325_4 and the joint assembly 323_8 is connected to the other end of the base portion 325_4.

In the working arrangement (FIG. 3A), the base portions 325_1 and 325_3 extend in the X direction between the support structures 322a and 322b, and the base portions 325_2 and 325_4 extend in the X direction between the support structures 322b and 322c. The support structures 322a, 322b, 322c extend in the Y direction and are perpendicular to the base portions 325_1, 325_2, 325_3, 325_4. The base portions 325_1, 325_2, 325_3, 325_4 have an extent in the X direction such that the pole 330a and the pole 330b are separated in the X direction by a distance 329, and the pole 330b and the pole 330c are separated in the X direction by the distance 329. The distance 329 is the dielectric distance such that there is no arcing between the poles 330a, 330b, 330c during ordinary operation of the capacitor bank. The joint assemblies 323 are locked to maintain the relative arrangement of the support structures 322a, 322b, 322c, 322d and the base portions 325_1, 325_2, 325_3, 325_4.

To transition the frame 320 to the transport arrangement, the joint assemblies 323 are unlocked. The base portions 325_1 and 325_3 are rotated about the respective joint assemblies 323_2 and 323_6 in the X-Y plane until the base portions 325_1 and 325_3 are parallel with the support structure 322b. The base portions 325_1 and 325_3 also rotate at the respective joint assemblies 332_1 and 323_5 such that the base portions 325_1 and 325_3 rotate relative to the support structure 322a. After rotation, the support structure 322a is parallel with the support structure 322b but is offset relative to support structure 322b in the Y direction, as shown in FIG. 3B. The base portions 325_2 and 325_4 are rotated in a similar manner to complete the transformation to the transport arrangement that is shown in FIG. 3B. After the transition to the transport arrangement is complete, the locking assemblies 323 are locked to maintain the frame 320 in the transport arrangement.

In the transport arrangement, the support structures 322a and 322c are parallel to each other and to the support structure 322b. The support structures 322a and 322c are laterally displaced in the Y direction by the same amount relative to the support structure 322b. The transformation between the working arrangement and the transport arrangement (and vice versa) and the locking and unlocking of the joint assemblies 323 may be done manually and without the aid of a motor or other external device.

In the implementation shown in FIGS. 3A and 3B, an attachment base 321 extends in the −Z direction from each connector plate 335_1, 335_2. The attachment base 321 may be used to secure the system 300 in the facility 192 (FIG. 2B) or in the transportation platform 190 (FIG. 2A). For example, the attachment base 321 may be bolted to a sturdy object (such as a floor) in the facility 192 or in the transportation platform 190. When the attachment base 321 is secured to the sturdy object, the support structure 322b is also secured and does not move relative to the sturdy object. In this configuration, the support structures 322a and 322c can move relative to the sturdy object and can rotate relative to the support structure 322b.

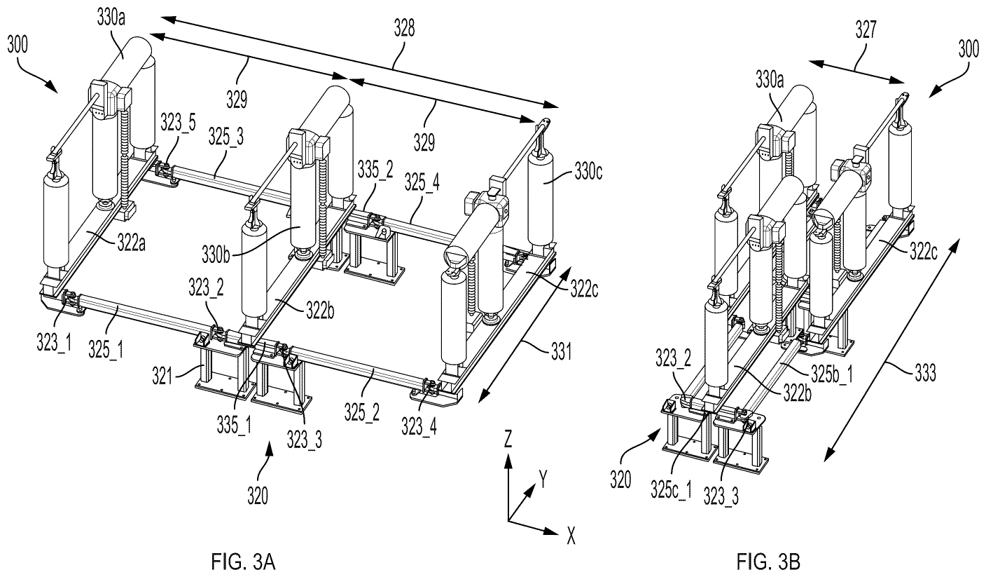

FIGS. 4A-4D are top views of another example articulating frame 420. The articulating frame 420 may be used with any three-phase electrical apparatus, such as the electrical apparatus 130 or an electrical apparatus that includes the phase components 330a, 330b, 330c. FIG. 4A shows the frame 420 in the working arrangement, FIGS. 4B and 4C show the frame 420 while transitioning to the transport arrangement, and FIG. 4D shows the frame 420 in the transport arrangement.

The frame 420 includes support structures 422a, 422b, 422c; joint assemblies 423_1, 423_2, 423_3, 423_4, 423_5, 423_6, 423_7, 423_8; and base portions 425_1, 425_2, 425_3, 425_4. The support structures 422a, 422b, 422c and the base portions 425_1, 425_2, 425_3, 425_4 may be made with any sturdy material, such as, for example, metal (for example, aluminum) or a rugged polymer. In some implementations, the base portions 425_1, 425_2, 425_3, 425_4 are made of a hollow metal pipe with a square cross-section, similar to the supports in the traditional frame. The length of the base portions 425_1, 425_2, 425_3, 425_4 are such that, when the frame 420 is in the working arrangement, the support structure 422a and the support structure 422b are separated by the dielectric distance appropriate for the electrical apparatus that the frame 420 is designed to hold. Each joint assembly 423_1, 423_2, 423_3, 423_4, 423_5, 423_6, 423_7, 423_8 (collectively referred to as the joint assemblies 423) allows a connected base portion to rotate through a 90 degree (°) arc in the X-Y plane.

Each base portion 425_1, 425_2, 425_3, 425_4 is connected to two joint assemblies as follows: one end of the base portion 425_1 is connected to the joint assembly 423_1 and the other end of the base portion 425_1 is connected to the joint assembly 423_2, one end of the base portion 425_2 is connected to the joint assembly 423_3 and the other end of the base portion 425_2 is connected to the joint assembly 423_4, one end of the base portion 425_3 is connected to the joint assembly 423_5 and the other end of the base portion 425_3 is connected to the joint assembly 423_6, one end of the base portion 425_4 is connected to the joint assembly 423_7 and the other end of the base portion 425_4 is connected to the joint assembly 423_8.

FIG. 4A shows the frame 420 in the working arrangement. In the working arrangement, the base portions 425_1, 425_2, 425_3, 425_4 are perpendicular to the support structures 422a, 422b, 422c. In the example of FIG. 4A, the base portions 425_1, 425-2, 425_3, 425_4 extend in the X direction, and the support structures 422a, 422b, 422c extend in the Y direction.

FIGS. 4B and 4C show the frame 420 being transitioned to the transport arrangement. Referring to FIG. 4B, the base portions 425_1 and 425_3 are rotated about the respective joint assembly 423_2 and 423_6 along an arc 426a in the X-Y plane. The base portions 425_1 to 425_3 may be moved along the arc 426a manually by an operator. For example, the base portions 425_1 to 425_3 may be moved along the arc 426a by grasping the base portion 425_1 and pushing it along the arc 426a. The base portions 425_1 and 425_3 also rotate about the respective joint assembly 423_1 and 423_5, causing the support structure 422a to move laterally in the Y direction. The base portions 425_1 and 425_3 are able to rotate 90° from their position in the working arrangement. FIG. 4C shows the base portions 425_1 and 425_3 at the end of their range of motion, with the base portions 425_1 and 425_3 extending in the Y direction.

The base portions 425_2 and 425_4 are moved along an arc 426b (FIG. 4B) in a similar manner to transition the frame 420 to the transport arrangement shown in FIG. 4D. When in the transport arrangement, the frame 420 has a smaller extent in the X direction than when the frame 420 is in the working arrangement.

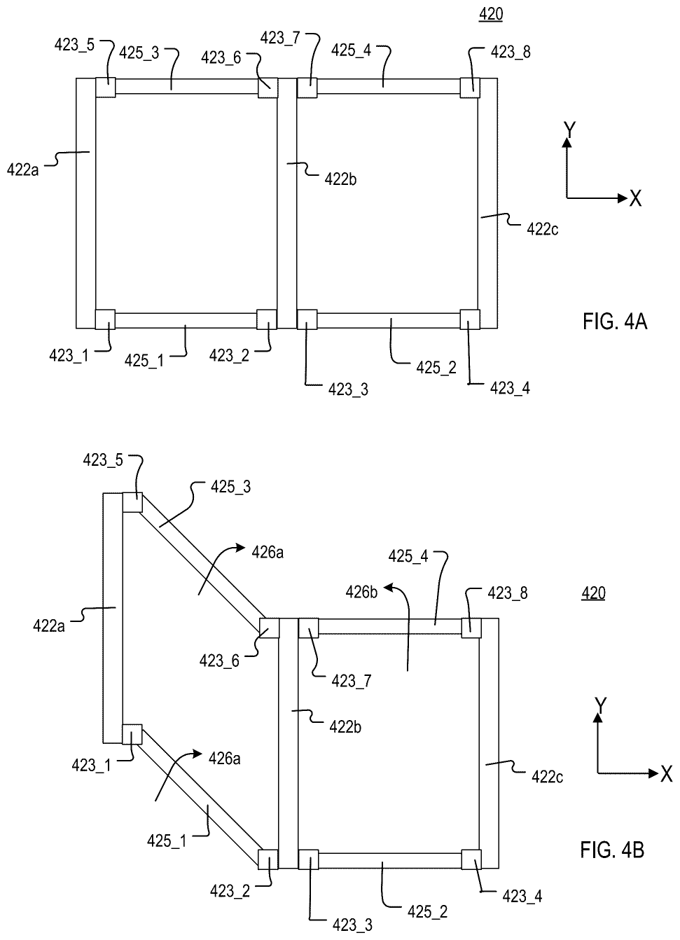

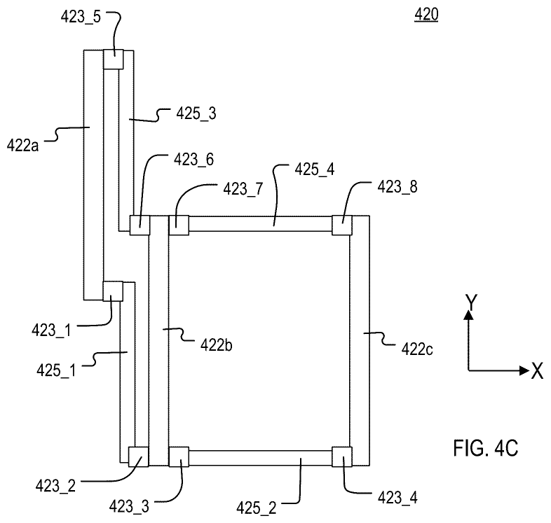

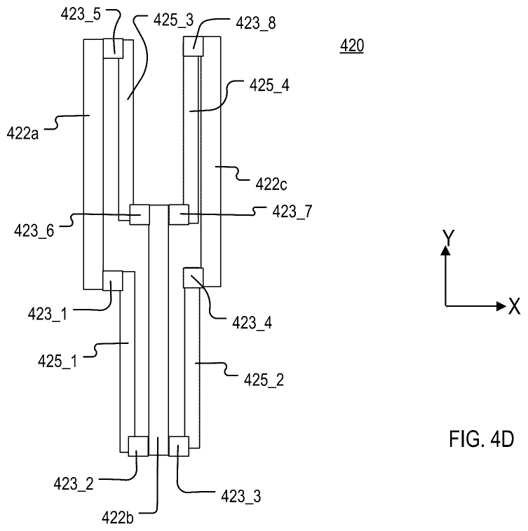

FIG. 5A is a perspective side view of a joint 540 for an articulating frame, such as the frame 120, 320, or 420. The joint 540 is an example of a joint that may be used in the joint assemblies 323 or 423. The joint 540 includes a first joint portion 541 (also shown in FIG. 5B) and a second joint portion 545 (also shown in FIG. 5C) that are connected by a pin 546. In the example of FIG. 5A, the first joint portion 541 is attached to a connector beam 535 that is attached to a support structure 522, and the second joint portion 545 is attached to a base portion 525.

The first joint portion 541 includes a mounting plate 543 and flanges 542a, 542b that extend perpendicularly from a surface 548 of the mounting plate 543. Each flange 542a, 542b defines a respective passage 544a, 544b. The passages 544a, 544b are the same size and the centers of the passages 544a and 544b are aligned in the Z direction. A side of the mounting plate 543 that is opposite to the surface 548 is attached to the support structure 522 to mount the first joint portion 541 to the support structure 522. The mounting plate 543 may be attached to the support structure 522 by, for example, welding or soldering, or by an adhesive bond.

The second joint portion 545 includes a mounting plate 549 and a flange 551 that extends perpendicularly from a surface 553 of the mounting plate 549. The flange 551 defines a passage 547. A side of the mounting plate 549 opposite to the surface 553 is attached to the base portion 525 to mount the second joint portion 545 to the base portion 525. The mounting plate 549 may be attached to the base portion 525 by, for example, welding or soldering, or by an adhesive bond.

To assemble the joint 540, the first joint portion 541 and the second joint portion 545 are positioned such that the centers of the passages 544a, 544b, and 547 fall on a line with the passage 547 between the passages 544a and 544b. The pin 546 is inserted into the passages 544a, 547, and 544b to join the first joint portion 541 and the second joint portion 545. When the joint 540 is assembled, the base portion 525 can rotate along the arc 526.

FIGS. 6A and 6B are perspective views of a joint assembly 623 that includes the joint 540. The joint assembly 623 may be used as the joint assemblies 323 or 423. The joint assembly 623 includes a joint assembly plate 657 that extends in the X-Y plane and defines two openings 658 and 660. Each opening 658 and 660 passes through the plate 657 in the Z direction and is configured to receive a locking pin 659. The connector beam 535 is attached to the joint assembly plate 657 by, for example, bolts, a weld or solder joint, or an adhesive bond. The base portion 525 is not directly attached to the joint assembly plate 657. The joint assembly 623 also includes a damper 690.

The operation of the joint assembly 623 is discussed next. FIG. 6A shows the joint assembly 623 when the articulating frame that includes the joint assembly is in the transport arrangement. As shown in FIG. 6A, in the transport arrangement, the base portion 525 is parallel to the support structure 522 and both the base portion 525 and the support structure 522 extend in the Y direction. The joint assembly 623 is locked to hold the base portion 525 and the support structure 522 fixed relative to each other. A flange 570 that extends in the X-Y plane from the base portion 525 defines an opening (not shown) that passes through the flange 570 in the Z direction and overlaps the opening 660 in the plate 657.

The locking pin 659 is inserted into the opening in the flange 570 and the opening 660 to lock the joint assembly 623. The locking pin 659 is inserted into and removed from the opening in the flange 570 and the opening 660 manually and may be inserted and removed by a human operator or end-user. In some circumstances, it may be possible to remove and/or insert the locking pin 659 by directly grasping the locking pin 659 and manually applying force to the locking pin 659 without the use of any tools. However, manual insertion and/or removal of the locking pin 659 also may be achieved with the use of hand-operated tools such as, for example, pliers.

FIG. 6B shows the joint assembly 623 when the articulating frame is in the working arrangement. To transition to the working arrangement, an operator or user of the articulating frame removes the locking pin 659. After the locking pin 659 is removed, the base portion 525 is free to rotate about the pin 546. The operator or user grasps the base portion 525 and moves the base portion 525 in the X-Y plane along an arc 526. The base portion 525 (and the flange 570) rotate until the base portion 525 encounters the damper 690 and the base portion 525 extends perpendicularly from the support structure 522. After moving the base portion 525 to this position, the opening in the flange 570 overlaps with the opening 658. To lock the joint assembly 623, the operator or user of the articulating frame inserts the locking pin 659 through the opening in the flange 570 and the opening 658.

Thus, the joint assembly 623 allows the base portion 525 to rotate through a 90° arc in one plane relative to the base portion 525. The joint assembly 623 may be locked at either end of the 90° range of rotation.

FIGS. 7A and 7B are perspective views of another joint assembly 723 that includes the joint 540. The joint assembly 723 is similar to the joint assembly 623, except the joint assembly 723 is smaller and does not include the damper 690. The joint assembly 723 is another example of a joint assembly that may be used in an articulating frame. FIG. 7A shows the joint assembly 723 when the articulating frame is in the transport arrangement. FIG. 7B shows the joint assembly 723 when the articulating frame is in the working arrangement.

The joint assembly 723 includes a joint assembly plate 757 that defines openings 758 and 760. The joint assembly plate 757 is attached to the support structure 522. When the articulating frame is in the transport arrangement (FIG. 7A), the opening in the flange 570 coincides with the opening 760. The joint assembly 723 is locked by inserting the locking pin 659 into the opening in the flange 570 and the opening 760.

To transition the articulating frame to the working arrangement (FIG. 7B), the operator or user of the frame removes the locking pin 659 and rotates the base portion 525 until the base portion 525 is perpendicular to the support structure 522. To lock the frame in the working arrangement, the locking pin 659 is inserted into the opening in the flange 570 and the opening 758.

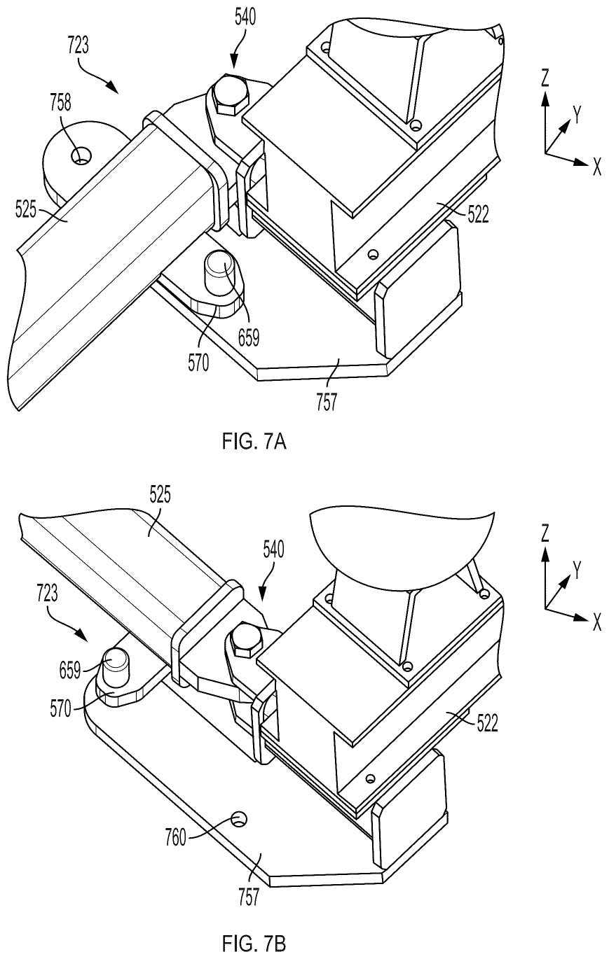

FIG. 8 shows a perspective view of the locking pin 659 when it is inserted into the opening in the flange 570 and an opening in the plate 657. The locking pin 659 includes a head 870 that has a larger cross-section in the X-Y plane than the opening in the flange 570 and the opening in the plate 657. The head 870 retains the locking pin 659 in place and prevents it from falling through the openings. The locking pin 659 also includes a tapered bottom region 872. The tapered bottom region 872 facilitates the insertion of the locking pin 659 into the openings.

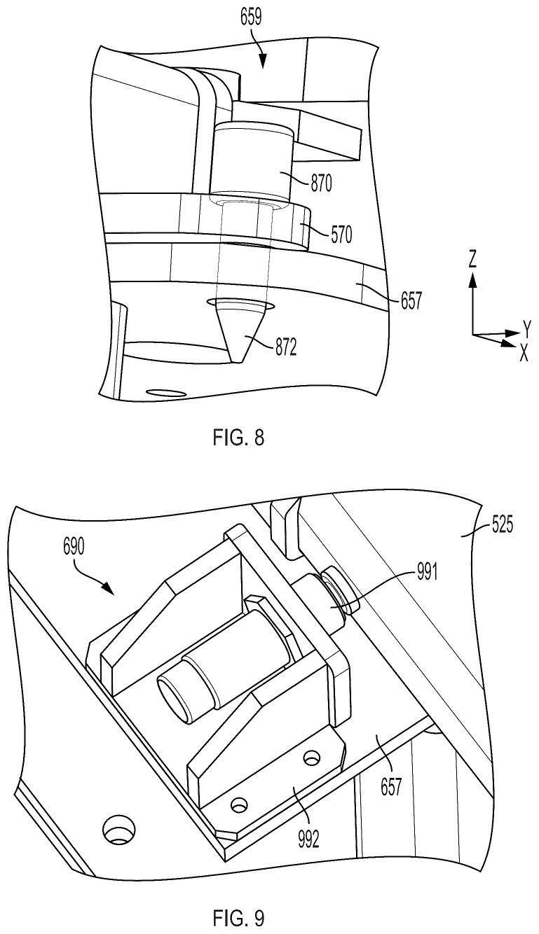

FIG. 9 is a perspective top view of the damper 690. The damper 690 includes a body 992 that attaches the damper 690 to the joint assembly plate 657. The damper 690 also includes an absorber 991 that extends from the body 992 in the Y direction. The absorber 991 interacts with the base portion 525 when the base portion 525 rotates to the position associated with the working arrangement. The absorber 991 absorbs mechanical vibrations, reduces the amount of bounce that the base portion 525 experiences when reaching the end of the arc 526, and helps to maintain the integrity of the articulating frame and the electrical apparatus supported by the frame.

The absorber 991 is any type of device that absorbs mechanical vibrations. Examples of the absorber 991 include, without limitation, a spring, a foam rubber structure, a gel, or a combination of such materials.

These and other implementations are within the scope of the claims.

What is claimed is:

1. A mobile electrical system comprising:
a frame configured to be transitioned between a working arrangement and a transport arrangement, the frame comprising:
a first support structure; a second support structure; and a third support structure;
a first base portion attached to the first support structure at a first joint assembly and to the second support structure at a second joint assembly, the first base portion configured to rotate relative to first support structure at the first joint assembly and to rotate relative to the second support structure at the second joint assembly; and
a second base portion attached to the second support structure at a third joint assembly and to the third support structure at a fourth joint assembly, the second base portion configured to rotate relative to the second support structure at the third joint assembly and the rotate relative to the third support structure at the fourth joint assembly;
a first phase component of an electrical apparatus mounted to the first support structure;
a second phase component of the electrical apparatus mounted to the second support structure; and
a third phase component of the electrical apparatus mounted to the third support structure, wherein,
when the frame is in the working arrangement, the first base portion extends substantially perpendicular to the second support structure such that the first phase component of the electrical apparatus and the second phase component of the electrical apparatus are separated at least by a dielectric breakdown distance, and the second base portion extends substantially perpendicular to the second support structure such that the second phase component of the electrical apparatus and the third phase component of the electrical apparatus are separated at least by the dielectric breakdown distance; and,
when the frame is in the transport arrangement, the first base portion and the second base portion are substantially parallel to the first support structure, the second support structure, and the third support structure; and a width of the frame is less than the width of the frame in the working arrangement.

2. The system of claim 1, wherein
the first joint assembly comprises a first locking mechanism configured to hold the first base portion perpendicular to the first support structure when the frame is in the working arrangement and to hold the first base portion parallel to the first support structure when the frame is in the transport arrangement;
the second joint assembly comprises a second locking mechanism configured to hold the first base portion perpendicular to the second support structure when the frame is in the working arrangement and to hold the first base portion parallel to the second support structure when the frame is in the transport arrangement;
the third joint assembly comprises a third locking mechanism configured to hold the second base portion perpendicular to the second support structure when the frame is in the working arrangement and to hold the second base portion parallel to the second support structure when the frame is in the transport arrangement; and
the fourth joint assembly comprises a fourth locking mechanism configured to hold the second base portion perpendicular to the third support structure when the frame is in the working arrangement and to hold the second base portion parallel to the third support structure when the frame is in the transport arrangement.

3. The system of claim 2, wherein
the first base portion comprises: a first flange that defines a first flange opening, and a second flange that defines a second flange opening; and
the second base portion comprises: a third flange that defines a third flange opening, and a fourth flange that defines a fourth flange opening.

4. The system of claim 3,
wherein the first locking mechanism comprises: a first plate that defines a working position opening and a transport position opening, and a first pin;
wherein the second locking mechanism comprises: a second plate that defines a working position opening and a transport position opening, and a second pin;
wherein the third locking mechanism comprises: a third plate that defines a working position opening and a transport position opening, and a third pin; and
wherein the fourth locking mechanism comprises: a fourth plate that defines a working position opening and a transport position opening, and a fourth pin.

5. The system of claim 1, wherein the electrical apparatus comprises a capacitor bank rated for at least 150 kilovolts (kV).

6. The system of claim 1, wherein each of the first phase component, the second phase component, and the third phase component comprises a capacitor, an arrester, and a line connection.

8. The system of claim 1, wherein each of the first joint assembly, the second joint assembly, and the third joint assembly comprises a damper.

9. A frame for an electrical apparatus, the frame comprising:
a plurality of support structures configured to hold one phase component of the electrical apparatus; and
a plurality of base portions, each connected to first joint assembly on a first one of the plurality of support structures and to a second joint assembly on a second one of the plurality of support structures; wherein
each base portion is configured to rotate about a joint in the first joint assembly and a joint in the second joint assembly between a working position and a transport position.

10. The frame of claim 9, wherein each joint assembly is lockable in the working position and the transport position.

11. The frame of claim 10, wherein each joint assembly comprises a locking pin, and
when the locking pin is inserted in the joint assembly, the joint assembly is locked; and
when the locking pin is not inserted in the joint assembly, the joint assembly is unlocked.

12. The frame of claim 9, wherein the base portion is configured to be rotated about the joints in response to manual manipulation.

13. The frame of claim 9, wherein each of the first and second joint assemblies comprises a damper configured to interact with one of the base portions when the base portion is rotated into the working position.
